(19) United States
(12) Patent Application Publication
(10) Pub. No.: US 2006/0020634 A1
(43) Pub. Date: Jan. 26, 2006

(54) Method, system and program for recording changes made to a database

(75) Inventors: Matthew Albert Huras, Ajax (CA); Sarah Posner, Toronto (CA); James William Van Fleet, Austin, TX (US); Roger Luo Quan Zheng, Scarborough (CA)

Correspondence Address: SUGHRUE MION PLLC;USPTO CUSTOMER NO WITH IBM/SVL, 2100 PENNSYLVANIA AVENUE, N.W., WASHINGTON, DC, 20037, US

(73) Assignee: International Business Machines Corporation, Armonk, NY (US)

(21) Appl. No.: 10/896,272

(22) Filed: Jul. 20, 2004

(51) Int. Cl. G06F 17/30

(52) U.S. Cl. 707/200

(57) ABSTRACT

A method, computer program product and database management system for recording a change to a database in a log including a plurality of log records. The database management system is capable of concurrently processing and logging multiple database changes. A tracking descriptor is used in conjunction with first and second identifiers for each log record to reduce the amount of logic executed using latching for each log record.

### FIELD OF THE INVENTION

The present invention relates to database management systems in general, and more particularly the present invention relates to a method, a system and a computer program product for recording changes made to a database.

### BACKGROUND

Databases are useful tools for storing, organizing, and accessing data and information. A database stores data in data containers including records having one or more data fields. Database management systems (DBMSs) are often used by database users to control the storage, organization, and retrieval of data (fields, records and files) in a database. In relational databases, the data container is a relational table made up of rows and columns. Each row represents a record and the columns are fields in those records. Many DBMSs are implemented in a client/server environment.

A log or journal is used to record changes to the database. The log comprises a number of log records including information about the changes to the database. Log records may be retrieved for recovery purposes (such as rollback operations), security purposes, (such as identifying illegal operations performed by unauthorized users), or any other purpose that requires access to previously processed operations.

In a typical DBMS implementation, changes to the database are recorded in the log with the following considerations: log data is eventually written to permanent storage to be used for recovery (e.g. in the event of a system crash); logging of operations is used to provide an ordering for these events; identifiers associated with the log records may be used to retrieve select log records or log data at a later time; the identifiers associated with the log records can be compared to determine the ordering of logged operations; and a timestamp is required for some log records and the order of the timestamp values for these log records is required to follow the log record order and be uniquely increasing.

Known systems for logging changes to database typically use a log consisting of a temporary portion and a permanent portion for efficiency of input/output. The temporary portion is used to record details of database operations such as changes to the database as they are performed. The temporary portion is known as a log buffer and resides in the memory of the DBMS. The contents of the temporary portion are periodically transferred to permanent portion, for example when the log buffer becomes full. In concurrent processing environment where multiple requests to perform a database change may be executed at the same time, multiple log records must also be written at the same time. In such cases, serialization is required to establish the proper ordering of log records and ensure that the log records are written to a proper location in the log buffer.

Known serialization implementations use a logic latch to ensure that each log record has been successfully written to the log buffer before a new log record is written. This solution provides proper ordering of the log records and ensures that each log record has its own space in the log buffer. A drawback of this solution is that it creates a contention problem between log records being written since each log record must access the latch. This problem is aggravated in multiprocessing environments such as large symmetric multiprocessing (SMP) systems where a large number of users may be making changes to the database at the same time.

Existing latch logic implementations must protect many concepts including: generating an identifier for each log record; determining a location in the log buffer for copy the log record into; ensuring the log buffer has enough room to hold the new log record; tracking the completion of the copying of log records into the log buffer so that the data available for writing to permanent storage is known; ensuring any timestamps in the log records are generated in the correct order; and allowing log data in the log buffer to be read while preventing the log data from being overwritten by new log records copied into the log buffer.

A known solution to reduce contention is to reduce the frequency with which the logic latch is used. Typically, multiple log records are grouped and recorded in separate memory areas before being posted to the log as a group. Log records are posted to the log according to a predetermined scheme, for example, when a separate memory area becomes full, or in cases where the log records relate to a single transaction, when the transaction is committed. This solution reduces contention by reducing the frequency with which the latch used, however the overhead associated with this type of implementation is still significant because the latch must still protect the concepts described above by performing the logic for these concepts within the latch.

In view of the problems associated with known database logging implementations, there remains a need for an improved method for recording database changes in a log that reduces contention and system overhead.

### SUMMARY

The present invention provides a method, computer program product and database management system for recording changes to the database in a log that reduces contention created by database logging. In one aspect, log contention is reduced by reducing the logic implemented under the main logic latch. In another aspect, log contention is reduced by executing logic normally implemented under the main logic latch to be executed without latching. Timestamps may be generated for log records recorded using either of these approaches.

In accordance with one aspect of the present invention, there is provided for a database management system, the database management system being capable of concurrently processing and logging multiple database changes, a method for recording a change to a database in a log, the log including a plurality of log records, the method comprising the steps of: generating a first identifier for mapping to an address in a log buffer for storing a log record describing the change; generating a second identifier for allocating a tracking descriptor for storing information concerning the log record; allocating a tracking descriptor for the log record from available tracking descriptors using the second identifier; and storing the log record at the address in the log buffer.

In accordance with another aspect of the present invention, there is provided a computer program product having a computer readable medium tangibly embodying code for directing a database management system to record a change to a database in a log, the log including a plurality of log records, the database management system being capable of concurrently processing and logging multiple database changes, the computer program product comprising: code for generating a first identifier for mapping to an address in a log buffer for storing a log record describing the change; code for generating a second identifier for allocating a tracking descriptor for storing information concerning the log record; code for allocating a tracking descriptor for the log record from available tracking descriptors using the second identifier; and code for storing the log record at the address in the log buffer.

In accordance with a further aspect of the present invention, there is provided a database management system for recording a change to a database in a log, the log including a plurality of log records, the database management system being capable of concurrently processing and logging multiple database changes, the database management system comprising: a log buffer; a logger module responsive to a change to the database, the logger module including, a module for generating a first identifier for mapping to an address in a log buffer for storing a log record describing the change; a module for generating a second identifier for allocating a tracking descriptor for storing information concerning the log record; a module for allocating a tracking descriptor for the log record from available tracking descriptors using the second identifier; and a module for storing the log record at the address in the log buffer.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 is a schematic diagram of a computer system suitable for practicing the present invention;

FIG. 2 is a block diagram of a data processing system for the computer system of FIG. 1;

FIG. 3 is a schematic diagram of an exemplary database management system (DBMS) suitable for utilizing the present invention;

FIG. 4 is a flowchart of a procedure for recording log records;

FIG. 5 is a flowchart of a procedure for determining the amount of data available for copying to permanent storage, the procedure for use with the procedure of FIG. 4;

FIG. 6 is a schematic diagram of a log buffer showing the log buffer in two different states;

FIG. 7 is a flowchart of another procedure for recording log records;

FIG. 8 is a flowchart of a procedure for determining the amount of data available for copying to permanent storage and generating timestamps, the procedure for use with the procedure of FIG. 7;

FIG. 9 is a flowchart of further procedure for recording log records;

FIG. 10 is a flowchart of another procedure for determining the amount of data available for copying to permanent storage and generating timestamps, the procedure for use with the procedure of FIG. 9;

FIG. 11 is a flowchart of a procedure for reading log records;

FIG. 12 is a flowchart of a procedure for copying log records to the log buffer; and

FIG. 13 is a flowchart of a procedure for copying log records from the log buffer to permanent storage.

Similar references are used in different figures to denote similar components.

### DETAILED DESCRIPTION OF THE EMBODIMENTS

The following detailed description of the embodiments of the present invention does not limit the implementation of the embodiments to any particular computer programming language. The computer program product may be implemented in any computer programming language provided that the OS (Operating System) provides the facilities that may support the requirements of the computer program product. A preferred embodiment is implemented in the C or C++ computer programming language (or may be implemented in other computer programming languages in conjunction with C/C++). Any limitations presented would be a result of a particular type of operating system, computer programming language, or data processing system and would not be a limitation of the embodiments described herein.

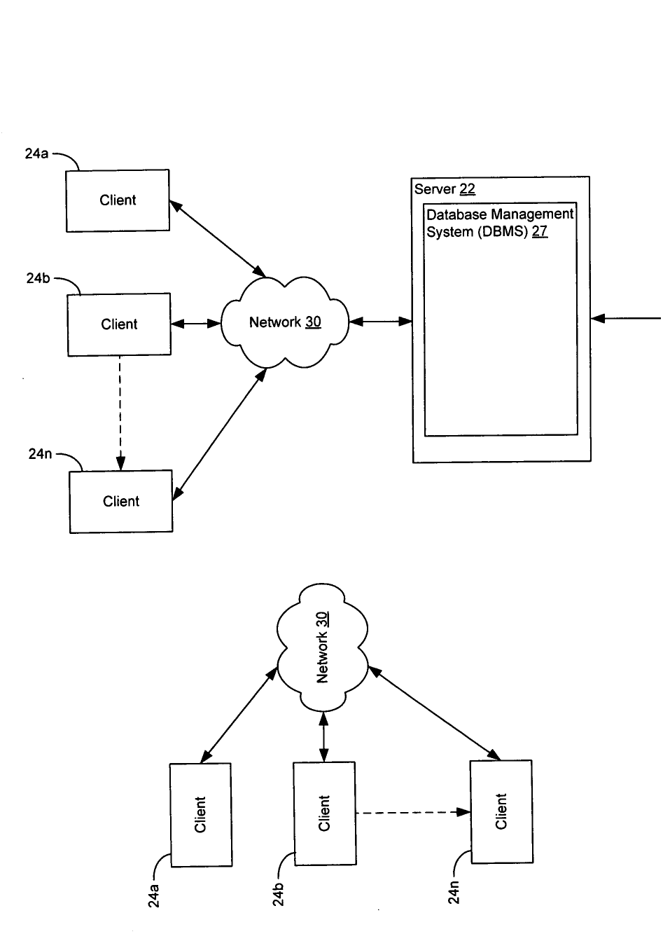

Reference is first made to FIG. 1, which shows a computer system 20 including a server 22 and clients 24, indicated individually by references 24a, 24b, . . . 24n, interconnected by a network 30. The server 22 may be modeled as a number of server components including a database server or database management system 27, for example, a relational database management system such as the DB2™ product from IBM™. The clients 24 may be single or multiprocessor computers, data processing systems, workstations, handheld portable information devices, or computer networks. The clients 24 may be the same or different. In one embodiment, the network 30 is the Internet or World Wide Web (WWW).

The computer system 20 further includes a database 26 and resources 28 connected to the network 30. The resources 28 comprise storage media, databases, a set of XML (extensible Markup Language) documents, a directory service such as a LDAP (Lightweight Directory Access Protocol) server, and backend systems. In some embodiments, data is stored across multiple databases. The interface between the server 22 and the database 26 and resources 28 may be a local area network, Internet, or a proprietary interface or combinations of the foregoing. The database 26 and resources 28 are accessed by the server 22 and/or the clients 24. Any of the server 22, the clients 24, the database 26 and the resources 28 is located remotely from one another or may share a location. The configuration of the computer system 20 is not intended as a limitation of the present invention, as will be understood by those of ordinary skill in the art from a review of the following detailed description. For example, in other embodiments the network 30 comprises a wireless link, a telephone communication, radio communication, or computer network (e.g. a Local Area Network (LAN) or a Wide Area Network (WAN)).

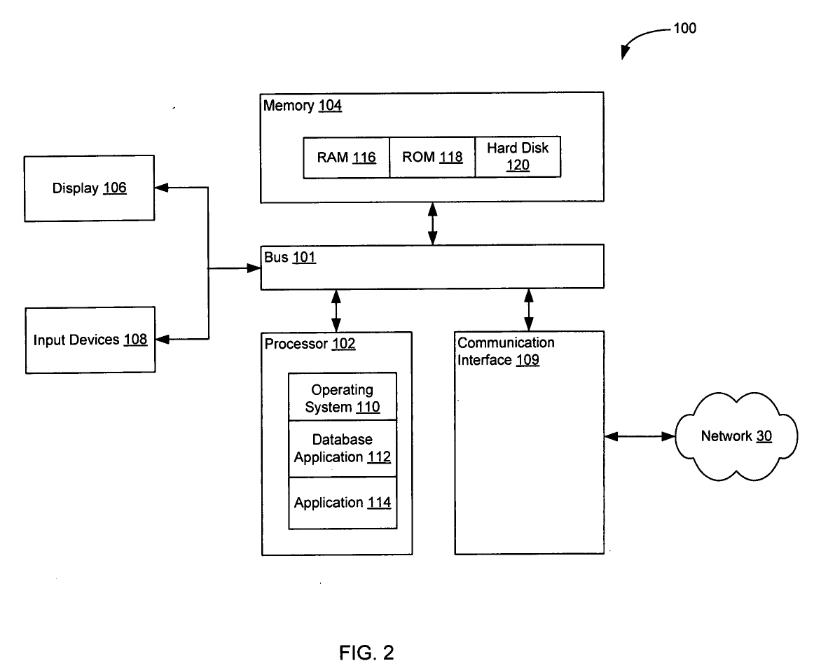

Reference is now made to FIG. 2, which shows a data processing system 100 in the computer system 20 (FIG. 1). The data processing system 100 comprises a processor 102, memory 104, display 106, and user input devices 108 such as a keyboard and a pointing device (e.g. mouse), and a communication interface 109 which are coupled to a bus 101 as shown. The communication interface 109 provides an interface for communicating with the network 30. An operating system 110, database application 112, and other application programs 114 run on the processor 102. The memory 104 includes random access memory (“RAM”) 116, read only memory (“ROM”) 118, and a hard disk 120. The data processing system 100 comprises a client or a server.

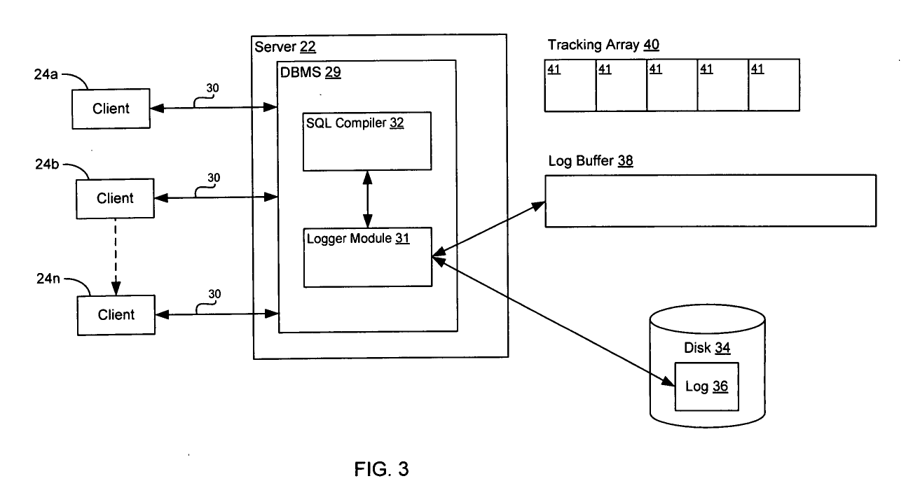

Referring now to FIG. 3, one embodiment of a database management system (DBMS) 29 according to the present invention is described. The DBMS 29 resides on a server 22 and is connection via the network 30 to clients 24, permanent or mass storage (“disk”) 34 (e.g., hard or fixed disk, removable or floppy disk, optical disk, magneto-optical disk, and/or flash memory), and a log buffer 38 stored in main memory 104 (e.g. RAM 116 or virtual memory (not shown)). In one embodiment, the DBMS 29 is a relational database management system (RDBMS) such as the DB2™ product from IBM™.

The DBMS 29 includes an SQL compiler 32 which receives and processes user requests, and a logger module 31 which maintains and manages a log 36 comprising a plurality of log records for recording changes made to the database 26. In this embodiment, the logger module 31 produces a single stream of log data (as opposed to multiple logs) in relation to database operations which perform changes in the database 26 (e.g. INSERT, UPDATE, DELETE, MERGE statements in the case of RDBMS embodiments). In RDBMS embodiments, database operations are requested by clients 24 in the form of SQL statements. Requests from multiple clients 24 may be received and concurrently processed by the DBMS 29.

For each change made to the database 26, the logger module 31 creates a log record describing the change. The log 36 includes a temporary portion stored in the log buffer 38 and a permanent portion stored on disk 34. The log buffer 38 comprises a circular buffer of fixed or pre-determined size. When the log buffer 38 is full, the next log record is written to the beginning of the log buffer 38. The log buffer 38 has a buffer limit that represents the space available in the buffer 38 to hold new log data without overwriting existing data. When a change is made to the database 26, the logger module 31 creates a log record in the log buffer 38. As the log buffer 38 is filled, the logger module 31 copies log records from the log buffer 38 to the disk 34 for permanent storage. As log records are written to disk 34, the buffer limit is increased (or moved up) by the amount of data that is written. When the log buffer 38 reaches the end of its space in memory 104, the log buffer 38 starts recording new log records at the beginning of the log buffer 38.

The log 36 may be viewed as having a physical stream and a logical stream. The physical stream is the log data written to disk 34. The log data on disk 34 comprises a number of units called log pages. Each log page includes metadata containing information about the log page which is used in organizing and maintaining the log 36. Typically, each log page contains log data preceded by a log page header and followed by a checksum.

The logical stream is stored in the log buffer 38 in memory 104 (e.g. RAM 116). The logical stream is the log data contained in the log pages but without the metadata (such as page header and checksum). The metadata is of fixed length to facilitate an easy mapping of a log record's position in the logical stream to its position in the physical stream. Any metadata implementation may be used so long as the metadata region in each log page is of fixed length.

To track the position of log records in the log buffer 38 and the disk 34, two separate identifiers are used. A log sequence number (LSN) is used to track the position in the physical log stream (i.e. the disk 34). A logical stream offset (LSO) is used to track the position in logical log stream (i.e. the log buffer 38).

The LSN corresponds to a physical address on the disk 34 or comprises a value which is used to derive a physical address on the disk 34. The value of the LSN identifier is an integer that represents the number of bytes in the physical log stream from the “beginning” of the log 36 where the “beginning” would have a LSN value of 0. LSN values are assigned in an increasing order. LSN values may also be used to represent a log record where the LSN value corresponds to the position in the physical stream of the first byte of data of a log record. However, not every LSN value represents a log record because most of the positions are not the first byte of the log record, and some LSN values are not log data positions but the position of a log page header or checksum.

Using the LSN as a log record identifier for the physical stream satisfies several logging requirements. Firstly, the LSN values give the ordering of log records. Given the LSN values for a set of log records, the ordering of these log records is easily determined. Secondly, using LSN values, log records may be efficiently located, for example for reading log data.

The LSO corresponds to a logical address in the log buffer 38 or comprises a value which is used to derive a logical address in the log buffer 38. The value of the LSO identifier is an integer that represents the number of bytes (of log data only) from the “beginning” of the logical log stream where the “beginning” would have an LSO value of 0. LSO values are assigned in an increasing order. LSO values may also be used to represent a log record where the LSO value corresponds to the position in the logical stream of the first byte of data for that log record.

Using LSO as a log record identifier also satisfies the logging requirement for ordering, and LSO values may be easily mapped to LSN values. Thus, given an LSO value a log record is efficiently located in the physical stream, for example for reading log data.

The copying of log records is monitored using a log record counter (LRC) and a tracking array 40. The LRC is a counter for the number of log records which is initialized at 0 and incremented by 1 for each log record. Thus, each log record may be associated with an LRC value. The tracking array 40 includes a plurality of tracking array elements 41. The tracking array 40 is used to track the progress of log record copying in the log buffer 38. The tracking array elements 41 are tracking descriptors associated with a log record and include information concerning the log record such as the LSO value for the record, the size of the record, and the status of the copying of the record into the log buffer 38. As will be described below, the information stored in the tracking descriptors is updated after the occurrence of each of a plurality of predetermined events. The plurality of predetermined events may include allocating a tracking descriptor (i.e. tracking array element 41) for the log record, storing the log record in the log buffer, copying the log record from the log buffer to permanent storage, and determining that the log record requires a timestamp.

According to this aspect, the tracking array 40 comprises a fixed size circular array. The size of tracking array 40 is configurable. The assignment of tracking array elements 41 for a log record is determined by dividing the LRC value for the log record by the tracking array size, where the tracking array size is defined by the parameter arraySize. The dividend of this calculation determines the position or index (i) of the tracking element 41 to be assigned in the tracking array 40.

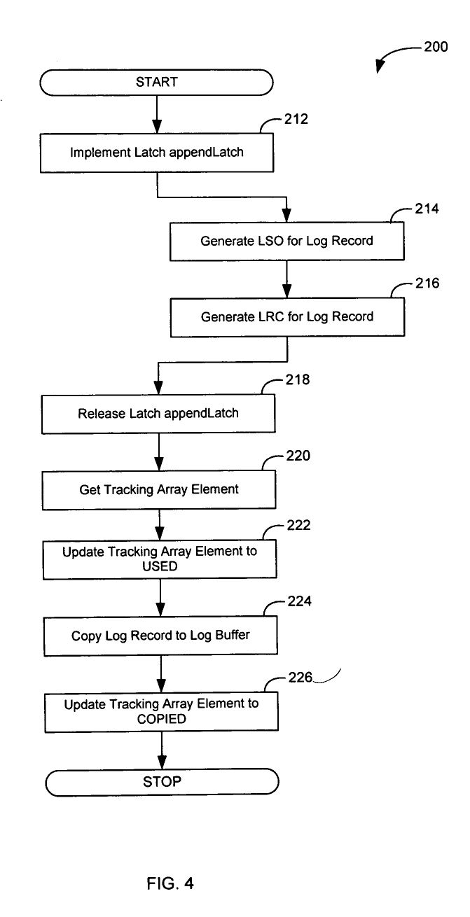

Referring now to FIG. 4, one embodiment of a method or procedure 200 for recording a log record describing a database change in the log buffer 38 (FIG. 3) is described. In the first step 212, a latch such as appendLatch is implemented to generate a unique LSO and LRC for the log record. Because multiple database operations may be processed concurrently, the possibility exists that multiple clients 24 (FIG. 3) may attempt to record a new log record at the same time. The use of a latch prevents the logic within the latch from being implemented for other log records at the same time. Latch implementations are known in the art.

In the next step 214, the logger module 31 (FIG. 3) generates an LSO value for the log record. As discussed previously, the LSO functions as a first identifier for mapping to an address in the log buffer for storing the log record. A parameter referred to as nextRecLso is used to represent the LSO value for the next log record to be written. The nextRecLso functions as a counter which is initialized to 0 and incremented by the size of each log record written to the log buffer 38 wherelog record size is defined by myLogRecSize. In step 214, the logger module 31 obtains the current value of nextRecLso and assigns this value to the log record. The nextRecLso is then updated by the size of the log record to determine the next LSO value.

In the next step 216, the logger module 31 generates an LRC value for the log record. As discussed previously, the LRC value functions as a second identifier for allocating a tracking descriptor for storing information concerning the log record. The logger module 31 determines the current value of the LRC and increments it for the log record. The parameter nextRecLrc represents the LRC value for the log record.

In the next step 218, the latch is released. Following the release of the latch, normal concurrent database logging resumes and LSO and LRC values may be obtained for another log record.

Next, a tracking array element 41 (FIG. 3) is allocated to the log record (step 220). As described above, the LRC value for the log record may be used to determine which tracking array element 41 will be used. In the next step 222, the tracking array element 41 for the log record is updated to indicate the element is being used. The tracking array element 41 is for the ordering of log records. After the LSO value has been assigned, the logger module 31 can easily determine the location in the log buffer 38 for copying the log record. Because the DBMS 29 is capable of logging database changes concurrently, the logger module 31 may copy log records into the log buffer 38 concurrently, independent of the progress of copying of other log records. Thus, the completion of log record copying into the log buffer 38 is not necessarily ordered. The tracking array 40 allows the logger module 31 to track the progress of log record copying so that, for example, the logger module 31 can determine at any given time how much data is available in the log buffer 38 to write to disk 34.

In the next step 224, the logger module 31 stores (copies) the log record in the log buffer 38 at the address mapped to by the LSO value generated in step 214. A procedure for copying log records to the log buffer 38 is described in more detail below. When the copying of the log record has been completed, the tracking array element 41 for the log record is updated to indicate the log record has been successfully copied (step 226). Other information about the log record may also be updated in the tracking array element 41, including information concerning the LSO value for the record and the size of the record.

An exemplary pseudo-code implementation (in part) of a method for recording a log record of size myLogRecSize in the log buffer 38 is shown below:

| | |
|---|---|
| take appendLatch; | /*implement latch*/ |
| returnLso = nextRecLso; | /*return last LSO value*/ |

| | |
|---|---|
| nextRecLso += myLogRecSize; | /*obtain new LSO |
| | value*/ |
| returnLrc = nextRecLrc; | /*return last LRC |
| | value*/ |

| | |
|---|---|
| nextRecLrc += 1; | /*update LRC for new log record*/ |
| release appendLatch; | /*release latch*/ |

| | |
|---|---|
| myTrackingEntry = getTrackingEntry(returnLrc); | /*obtain tracking |
| | array entry*/ |
| myTrackingEntry.appendEntryState = USED; | /*update tracking |
| status | array entry |
| | to USED*/ |
| myTrackingEntry.lrecSize = myLogRecSize; | /*update tracking |
| array entry size*/ | |
| myTrackingEntry.lrecLso = returnLso; | /*update tracking array |
| entry LSO*/ | |

| | |
|---|---|
| copyLogRecord(returnLrc, returnLso, myLogRecSize); | /*copy log record |
| to buffer*/ | |
| myTrackingEntry.appendEntryState = COPIED; | /*update tracking |
| entry | array |
| | status to |
| | COPIED*/ |

One embodiment of the tracking array 40 (FIG. 3) will now be described in more detail. The tracking array 40 is defined by the parameter trackingArray and each tracking array element 41 comprises a number of data fields including a appendEntryState field, a lrecLso field, a lrecSize field, and a nextLrcForEntry field.

The appendEntryState field includes information about the state of the log record. The appendEntryState field may have the value of FREE, USED or COPIED. A tracking array element 41 is FREE if it is available to be assigned to a new log record, i.e. if it has not been previously assigned or if the tracking array element 41 has been reset to FREE, for example after a log record has been copied to disk 34 for permanent storage. If no tracking array entries are FREE when the logger module 31 attempts to assign a tracking array element 41, the logger module 31 will attempt to free up a tracking array element 41. Tracking array elements 41 may be freed up by copying log records from the log buffer 38 to the disk 34 or by updating the status of log records that have been copied to disk 34 but have yet to have their tracking array element 41 reset to FREE.

If a log record has been assigned an entry but log data for that record has not yet been copied to the log buffer 38, the tracking array element 41 is marked as USED. If the logger module 31 has completed copying the log data into the log buffer 38 the tracking array element 41 is marked as COPIED. In some cases there may be a delay between the updating of tracking array element status due to the concurrent processing of client requests. For example, a log record may be copied to the buffer 38 and still have its status marked as USED for a short time.

The lrecLso field in the tracking array element 41 records the LSO value for the record. The lrecSize field records the size of the record. The nextLrcForEntry field is for cases where there are many clients 24 writing log records, and two records have LRC values that map to the same tracking array entry. The value of the nextLrcForEntry field determines which log record uses the tracking array element 41.

The nextLrcForEntry value for a tracking array element 41 is an LRC value of the log record which maps to the element 41 which is next in order to be written to the log buffer 38. For example, assuming the tracking array size is 4, but there are 10 different log records (assume all of the same size of 10) that are to be written at the same time. The log records get an LSO value of 0, 10, 20, 30 . . . 90, and LRC values of 0, 1, 2, 3 . . . 9. This creates the ordering of the 10 log records, but only the log records with LRCs of 0, 1, 2, 3 can fit into the tracking array 40. The remaining log records are waiting for the tracking array element 41 (which they map to) to be come FREE. In this case, the log records 4 and 8 (according to LRC value) both map to the track array element 0, and so they are both waiting for the element 0 to become available. When it eventually does become available, the log record mapping with the LRC value equal to the nextLrcForEntry value of the trackingArray element 0 (i.e. log record 4) is assigned the element.

The tracking array 40 is initialized with the ith element having a nextLrcForEntry value of i. Each time a tracking array element 41 is used, when the element 41 becomes FREE, the nextLrcForEntry value for that element 41 is increased by the size of the tracking array 40 (i.e. in the previous example, the size is 4). When deciding if a log record can use a tracking array element 41, the logger module 31 checks if the element is FREE and that its nextLrcForEntry value is the same as the LRC for the log record to be written. The tracking array 40 may be initialized according to the following exemplary pseudo-code implementation:

```
Function initializeTrackingArray( )
{
  for (i=0; i<trackingArraySize; i++)
  {
    trackingArray[i].appendEntryState = FREE;
    trackingArray[i].nextLrcForEntry = i;
  }
}
```

An exemplary implementation of a method for assigning tracking array elements 41 such that two log records are prevented from using the same tracking array element 41 is shown below in partial pseudo-code form:

```
Function getTrackingEntry(lrc)
{
  i = lrc % trackingArraySize;
  while(trackingArray[i].nextLrcForEntry != lrc ||
      trackingArray[i].appendEntryState != FREE)
  {
    get CopyComplete( );
    wait;
  }
  return(trackingArray[i]);
}
Function returnTrackingEntry(entry)
{
  entry.nextLrcForEntry += trackingArraySize;
  entry.appendEntryState = FREE;
}
```

The logger module 31 (FIG. 3) determines how much free space is available in the log buffer 38 and how much log data is available for writing to disk 34 using the tracking array 40 and parameters copyComplete and oldestUnfinished. The copyComplete parameter is the LSO value for which all prior log data (i.e. log data stored at lower LSO values) has been copied into the log buffer 38. This value is updated by the logger module 31 after a log record has been copied. The oldestUnfinished parameter is the oldest (lowest) LRC value that does not have its tracking array element 41 marked as COPIED. A procedure or function called getCopyComplete( ) may be used to evaluate the parameters oldestUnfinished and copyComplete. The getCopyComplete( ) procedure may be called at different times by different procedures of the DBMS 29, but is called most frequently by the logger module 31 after it has finished writing log records to disk 34 or during the freeing up of tracking array elements 41.

The getCopyComplete( ) procedure scans the tracking array 40 beginning at the tracking array element 41 indicated by the oldestUnfinished parameter. The tracking array 40 is then scanned forwards. The oldestUnfinished parameter is incremented for each tracking array element 41 marked as COPIED until a tracking array element 41 not marked as COPIED is reached. In this embodiment a latch is used to protect these parameters. This latch does not create a significant contention problem because it is used infrequently, usually by the logger module 31 after it has finished writing log records to disk 34.

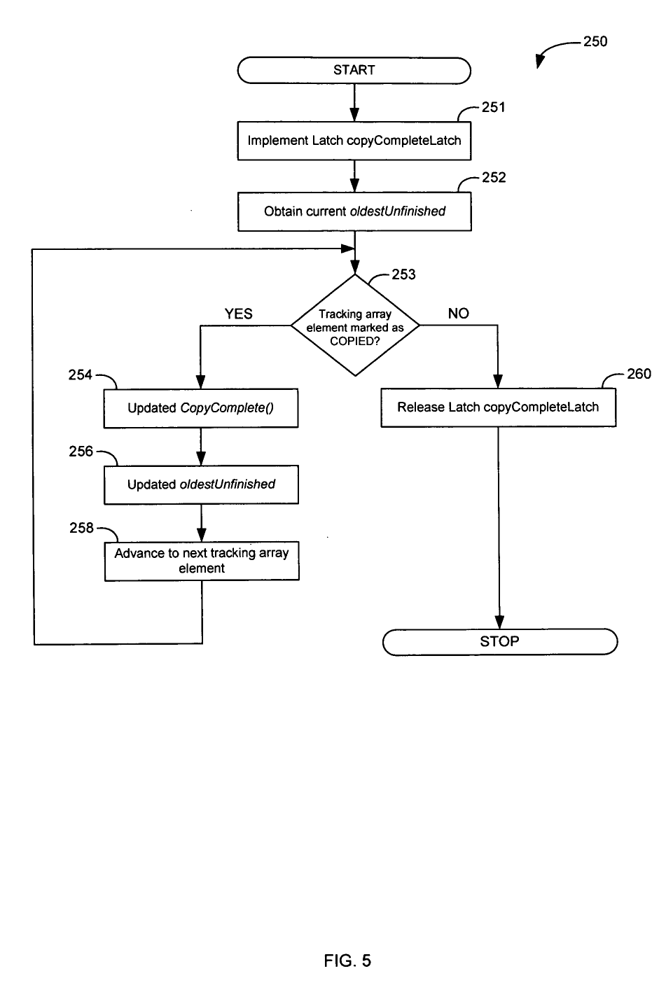

Referring now to FIG. 5, one embodiment of a procedure 250 for updating log information regarding the status of the log buffer 38 (e.g. available free space and log records available for writing to disk 34) is described. In the first step 251, a latch is implemented to prevent a status update from being executed by more than one user request. Next, the current value of the oldestUnfinished parameter is determined (step 252). Starting with the tracking array element 41 indicated by the oldestUnfinished parameter, the logger module 31 determines if the tracking array element 41 is marked as COPIED, e.g. in the appendEntryState field (decision block 253). If the tracking array element 41 is marked as COPIED, the copyComplete parameter is updated to the LSO value (e.g. in lrecLso field) associated with the tracking array element 41 (step 254). Next, the oldestUnfinished parameter is incremented (step 256). The logger module 31 then advances to the next tracking array element 41 and repeats steps 253 and on (step 258).

If the tracking array element 41 is not marked as COPIED, the logger module 31 stops scanning the tracking array 40 and the latch is released (step 260).

An exemplary pseudo-code implementation (in part) of the procedure getCopyComplete( ) for evaluating the parameters copyComplete and oldestUnfinished is shown below:

```
Function getCopyComplete( )
{
  take copyCompleteLatch;
  entry = trackingArray[oldestUnfinished % trackingArraySize];
  while (entry.appendEntryState == COPIED)
  {
    copyComplete = entry.lrecLso + entry.lrecSize;
    returnTrackingEntry(entry);
    oldestUnfinished += 1;
    pLrecEntry = &trackingArray[oldestUnfinished %
    trackingArraySize];
  }
  release copyCompleteLatch
}
```

As discussed above, the log buffer 38 (FIG. 3) comprises a circular buffer of fixed size which is stored in memory 104. Once the log buffer 38 is full, the next log record is written to the beginning of the log buffer 38. When copying log records into the log buffer 38, the logger module 31 needs to ensure there is enough free space in the log buffer 38 to hold the new data. A parameter called bufferLimit is used to address this aspect. The bufferLimit is an LSO value that represents a limit below which the log buffer 38 has space to hold new log data. It is initialized to the size of the log buffer 38, and is increased every time some log data from the log buffer 38 is written to disk 34.

From time to time, the logger module 31 is required to read log records that were previously written, for example for recovery purposes. At the time of a read request, it is possible that the log data is still in the log buffer 38. If possible the log data is read directly from the log buffer 38, thereby avoiding the expense of having to read the log data from disk 34.

To allow log data to be read from the log buffer 38, this log data is protected from being overwritten by new log records. This embodiment provides a compromise between the increased efficiency of allowing the logger module 31 to read data from the log buffer 38 while not adding too much overhead to protect log data in the log buffer 38 that is available for reading. This may be viewed as reserving a portion of the log data in the log buffer 38 to be unavailable for reading so new log records may be copied into the log buffer 38 without worrying that any user may be reading the old data at that location. If and when new log records to be written exceed this protected area, latching is used to coordinate the reading and the log buffer reuse.

To reserve a portion of the log buffer 38 for reading, a parameter called appendLimit is used. The appendLimit parameter is an LSO that is less than or equivalent to the bufferLimit. The appendLimit may be initialized to bufferLimit−readProtectedSize, where readProtectedSize is a portion of the log buffer 38, e.g. (bufferSize*75%), and does not change. After log data is written to disk 34, the bufferLimit is moved up and appendLimit is kept at least equal to bufferLimit−readProtectedSize. Thus, the log buffer 38 may copy new log records up the LSO value represented by the appendLimit. Log data above the appendLimit is protected from being overwritten. If the logger module 31 requires copying beyond the appendLimit, the appendLimit may be increased while the logger module 31 is not serving a read request.

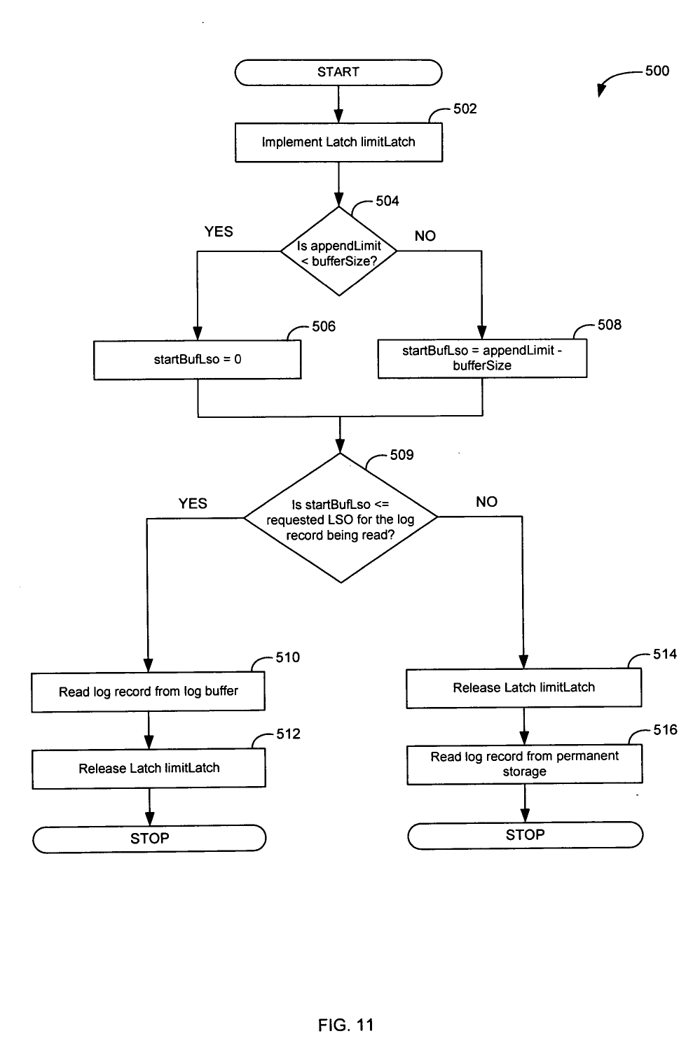

Referring now to FIG. 11, a method or procedure 500 of reading log records will now be described. It will be appreciated that at the time of reading the log record, the log record may have been copied from the log buffer 38 to permanent storage (e.g. disk 34). If the log record is still in log buffer 38 (it has not yet been overwritten by new log data), it is desirable to read the log record from the buffer 38 but in doing so the log record to be read must still be protected.

In the first step 502, a latch such as the latch limitLatch is implemented to prevent the value of bufferLimit or appendLimit from being changed. Next, the logger module 31 determines if the address of the log record is below a read limit address in the log buffer 38. This is a multi-step process. The logger module 31 first determines whether the value of appendLimit is less than the value of bufferSize (decision block 504). If the value of appendLimit is less than the value of bufferSize, the parameter startBufLso is set to 0 (step 506). If the value of appendLimit is not less than the value of bufferSize, the parameter startBufLso is set to appendLimit−bufferSize (step 508).

Next, the logger module 31 determines whether the value of startBufLso is less than or equal to the LSO of the log record to be read (decision block 509). If the value is startBufLso is less than or equal to the LSO, the log record is below the read limit address and is read from the log buffer 38 (step 510). After the record has been read, the latch is released thereby allowing the values of bufferLimit or appendLimit to be changed by the logger module 31 (step 512).

If the value of startBufLso is greater than the LSO, the log record cannot be read from the log buffer 38. The value of startBufLso can be viewed as a read limit address below which log records may be read from the log bugger 38 and above which log records are read from permanent storage. Further, it will be appreciated that while the latch limitLatch is implemented (taken) the value of the read limit address (i.e. startBufLso) is prevented from changing. In the next step 514 the latch is released. The log record is then read from permanent storage (step 516).

An exemplary pseudo-code implementation (in part) for reading a log record according to the procedure 500 is shown below:

```
Function readLogRecord(reqLso)
{
  take limitLatch;
  if (appendLimit < bufferSize)
      startBufLso = 0
  else
      startBufLso = appendLimit − bufferSize;
  if (startBufLso <= reqLso)
  {
      data is found in log buffer, extract it
      release limitLatch;
  }
  else
  {
      release limitLatch;
      read log record from disk;
  }
}
```

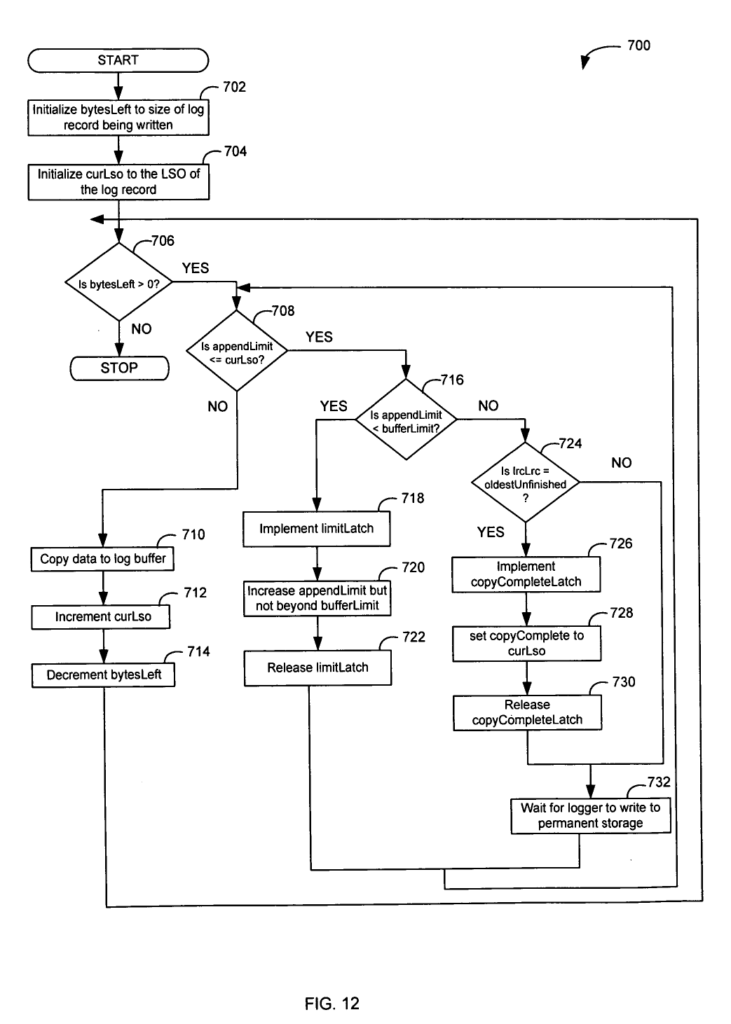

Referring now to FIG. 12, a method or procedure 700 for storing (copying) a log record in the log buffer 38 will be described. Before copying begins two parameters are initialized. In the first step 702, a parameter bytesLeft is set to the size of the log record to be copied. The parameter bytesLeft is used to track the status of the copying of the record. In the next step 704, a parameter curLso is set to the LSO of the log record to be copied.

Next, the logger module 31 determines if the bytesLeft parameter is greater than 0 (decision block 706). If the bytesLeft parameter is equal to 0, the log record has been copied and the procedure 700 terminates. If the bytesLeft parameter is greater than 0, the log record has not been completely copied and the logger module 31 proceeds with the copying procedure.

Next, the logger module 31 determines if the appendLimit parameter is less than or equal to curLso (decision block 708). If the appendLimit parameter is less than or equal to curLso, at least some of the log data of the log record still requires copying to the log buffer 38. The logger module 31 then copies log data to the buffer 38 (step 710). The amount of data to be copied is equal to bytesLeft or appendLimit−curLso, whichever is less (step 712). In the next step 714, curLso is incremented by the amount copied. Next, the bytesLeft parameter is decremented by the amount copied.

If the appendLimit parameter is greater than curLso (decision block 708) the log record has been completely copied to the log buffer 38. Next, the logger module 31 determines if the appendLimit parameter is less than the bufferLimit parameter (decision block 716). If the appendLimit parameter is less than the bufferLimit the appendLimit parameter must be increased, however the appendLimit cannot be increased during log record reading. In the next step 718, a latch such as the latch limitLatch is implemented to prevent log record reading. This latch is also taken log record reading so taking the latch limitLatch prevents reading from occurring. Next, the appendLimit parameter is increased but not beyond the bufferLimit (step 720). The latch is then released (step 722).

If the appendLimit parameter is not less than the bufferLimit parameter (decision block 716), the logger module 31 then determines if an lrcLrc parameter is equal to the oldestUnfinished parameter (decision block 724). If the lrcLrc parameter is equal to the oldestUnfinished parameter, the oldestUnfinished parameter represents the LRC value of the last log record copied and the copyComplete parameter is updated for the log record. In step 726, a latch such as the latch copyCompleteLatch is implemented to prevent other log records from affecting the copyComplete parameter. Next, the copyComplete parameter is set to curLso (step 728). The latch is then released (step 730).

If the lrcLrc parameter is not equal to the oldestUnfinished parameter, the logger module 31 waits for a predetermined amount of time (step 732) and re-evaluates the lrcLrc parameter (decision block 724).

An exemplary pseudo-code implementation (in part) for copying log records into the log buffer 38 is shown below:

```
Function copyLogRecord(lrcLrc, lrcLso, lrecSize)
{
  bytesLeft = lrecSize;
  curLso = lrecLso;
  while (bytesLeft)
  {
    while (appendLimit <= curLso)
    {
      if (appendLimit < bufferLimit)
      {
        take limitLatch
        increase appendLimit, but not beyond bufferLimit
        release limitLatch
      }
      else
      {
        if (lrcLrc == oldestUnfinished)
            {
            take copyCompleteLatch;
            copyComplete = curLso;
            release copyCompleteLatch;
        }
        wait a little for the logger to write data to disk;
      }
  }
  bytesInBuf = appendLimit − curLso;
  bytesToCopy = min(bytesInBuf, bytesLeft);
  copy bytesToCopy into buffer;
  curLso += bytesToCopy;
  bytesLeft −= bytesToCopy;
  }
}
```

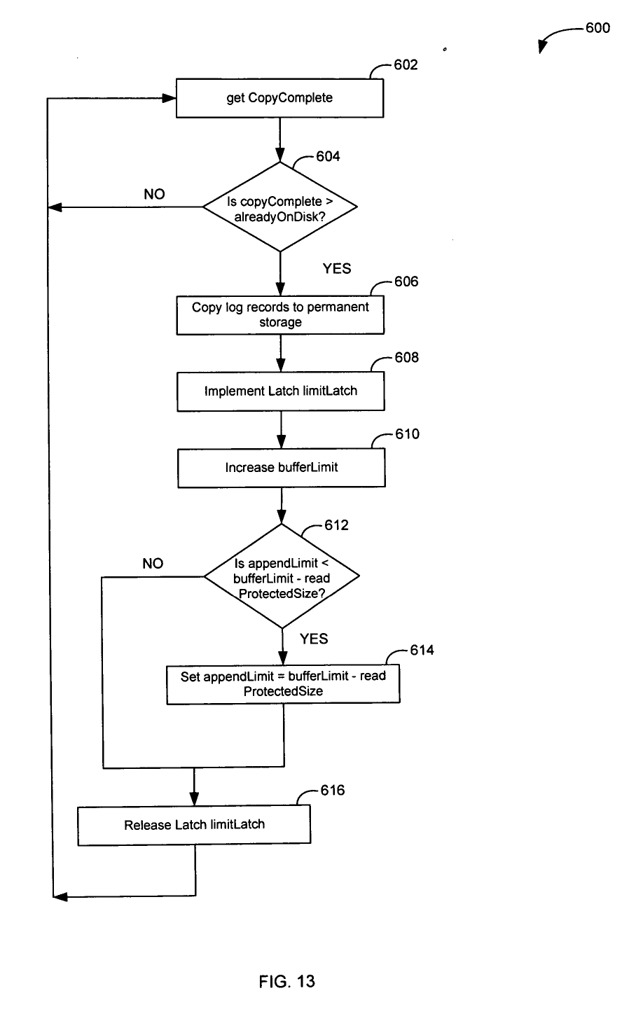

Referring now to FIG. 13, a method or procedure 600 for copying log records from the log buffer 38 to permanent storage (e.g. disk 34) will be described. The procedure 600 represents a loop performed by the logger module 31. The means by which the logger module 31 enters and exits the logic loop is not shown and is not relevant to the operation of the procedure 600.

First, the logger module 31 performs the copyComplete( ) procedure and determines the current value of the copyComplete parameter (step 602). Next, the logger module 31 determines if the copyComplete parameter is greater than the alreadyOnDisk parameter which represent an LSO value below which the log records have been copied to permanent storage e.g. disk 34 (decision block 604).

If the copyComplete parameter is greater than the alreadyOnDisk parameter, the log records with an LSO value below the copyComplete parameter may be copied to permanent storage. In step 606, the logger module 31 copies log records to permanent storage. In the next step 608, a latch such as the latch limitLatch is implemented to prevent other log records from affecting the appendLimit or bufferLimit parameters. Next, the bufferLimit parameter is increased by the amount of data copied to permanent storage (step 610).

Next, the logger module 31 determines if the appendLimit parameter is less than bufferLimit−readProtectedSize (decision block 612). If appendLimit parameter is less than bufferLimit−readProtectedSize, the appendLimit parameter is set to this value (step 614). Maintaining the appendLimit parameter in this way ensures that a portion the log buffer 38 is reserved for copying 38 without worrying that any user may be reading the old data at that location. The latch is then released (step 616). If appendLimit parameter is not less than bufferLimit−readProtectedSize (decision block 612) it does not need to be increased and the latch is released (step 616).

An exemplary implementation for adjusting the bufferLimit and appendLimit parameters is shown below in partial pseudo-code form:

```
Function loggerMainLoop( )
{
  loop
  {
    getCopyComplete( );
    if (copyComplete > alreadyOnDisk)
    {
      write new data to disk;
      take limitLatch
      move up bufferLimit;
      if (appendLimit < bufferLimit − readProtectedSize)
        appendLimit = bufferLimit − readProtectedSize;
      release limitLatch
    }
  }
}
```

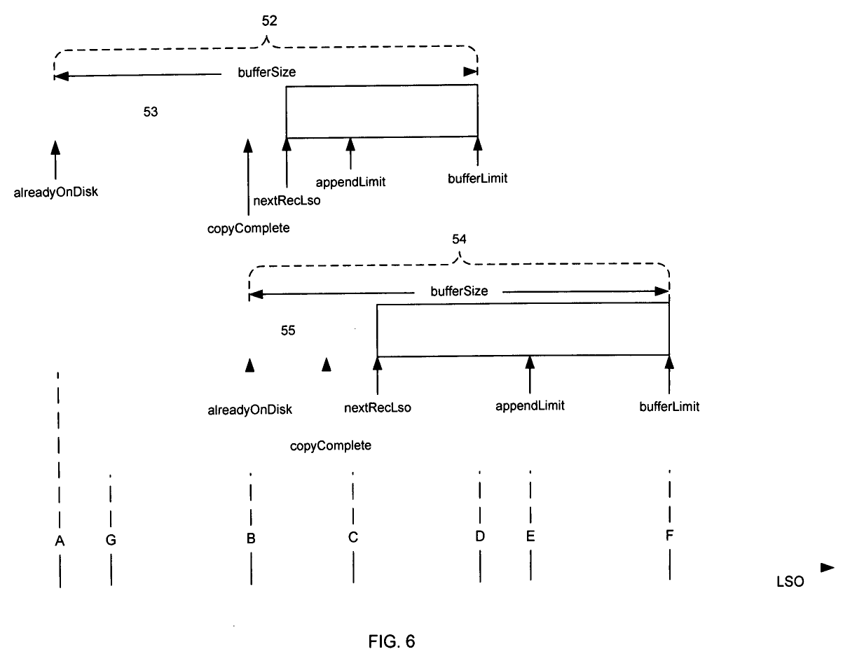

Referring now to FIG. 6, the log buffer 38 (FIG. 3) is explained in further detail. Log data is stored in the log buffer 38 in increasing order by LSO value. Two states 52 and 54 of the log buffer 38 are shown. The states 52 and 54 represent typical states of the log buffer 38, before and after the logger module 31 writes some data to disk. In the first state 52, the alreadyOnDisk value is indicated at reference A (i.e. log data up to this point has been copied from the log buffer 38 to disk 34), the copyComplete value is indicated at reference B (i.e. log data up to this point has been copied to the log buffer 38), the appendLimit value is indicated at reference C, and the bufferLimit value is indicated at reference D. NextRecLso represents the location for the next log record. The data between A and B (region 53) is available for copying to disk 34. The logger module 31 writes this data to disk 34 and moves up the bufferLimit and appendLimit by this same amount (B−A). The log buffer 38 is now in a second state 54.

In state 54, reference B is now the value of alreadyOnDisk, reference E is the value of appendLimit where E=F−readProtectedSize, and reference F is the value of bufferLimit where F=B+bufferSize. The following relationships should be noted: (F−D)=(E−C)=(B−A) and bufferSize=(D−A)=(F−B). While region 53 is being written to disk, more log records are generated in the log buffer 38 and so copyComplete and nextRecLso are moved up accordingly by unspecified amount. Region 55 (data between alreadyOnDisk and copyComplete) in state 54 represents data available for copying to disk 34 in the next iteration. Reference G in state 54, where G=E−bufferSize, represents the starting point where log data is available for reading directly from log buffer 38 without having to read from disk 34. In view of the above, it will be appreciated that log records that are still stored in the log buffer 38 and have an LSO below the appendLimit are read from the log buffer 38 whereas log records above the appendLimit are read from permanent storage (e.g. disk 34) as this space is allocated for new log record copying.

Although in the foreign example the logger module 31 wrote all the log data available for copying from the log buffer 38 to permanent storage (i.e. the entire region 53), this is not necessarily the case for every instance when the logger module 31 copies data to disk 24. In some cases, for whatever reason (e.g. maybe it is more convenient of logger 31) the logger module 31 may write less of the available data to disk 34. In such cases, the bufferLimit and appendLimit are moved up by the amount of data that is written without affecting the invention. A person of skill in the art would understand how to implement such a variation.

The foregoing embodiment provides a method for recording log records using a latch (e.g. appendLatch) to evaluate two parameters nextRecLrc and nextRecLso for each log record. This latch has a minimal cost of execution and creates low overhead because other respects of logging, including the copying of log data into the log buffer 38 and determining the free space available in the log buffer 38, are performed outside of the latch, thereby reducing contention. Other latches described are executed infrequently and not for each log record.

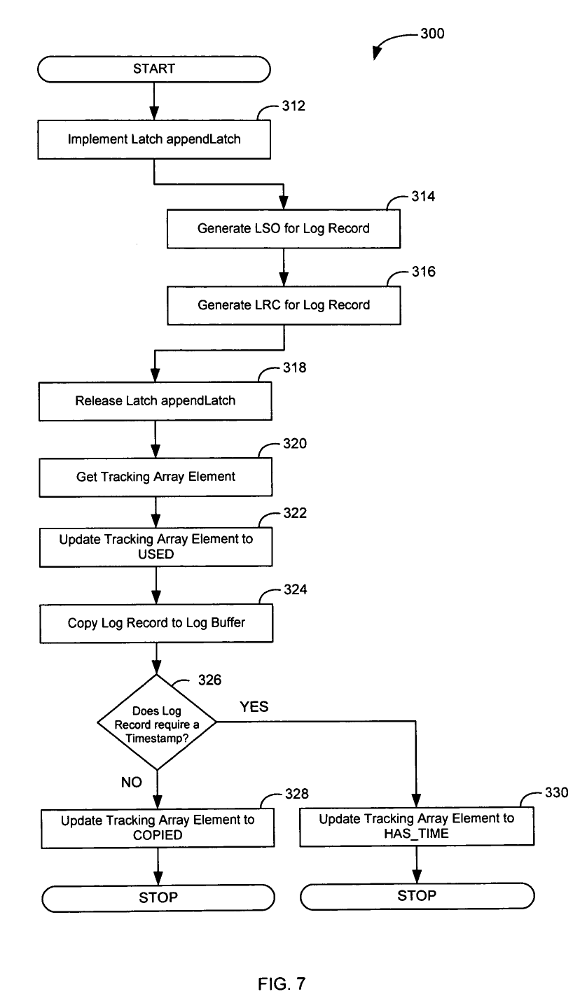

Referring now to FIG. 7, a procedure 300 for writing log records requiring a timestamp into the log buffer 38 is described. The procedure 300 is similar to the procedure 200, however some of the log records created require a timestamp, and there is a requirement that the timestamps on these log records be in the same increasing order as the log records. In this embodiment, the appendEntryState field of each tracking array element 41 may also have the value HAS_TIME. Log records having a tracking array element 41 marked as HAS_TIME will have a timestamp generated after the log record is copied into the log buffer 38. In the first step 312, a latch such as appendLatch is implemented to generate a unique LSO and LRC for the log record. Next, the logger module 31 generates an LSO value for the log record (step 314). In the next step 316, the logger module 31 generates an LRC value for the log record. The latch is then released (step 318). Following the release of the latch, normal concurrent database logging resumes and LSO and LRC values are obtained for another log record.

Next, a tracking array element 41 is assigned to the log record (step 320). The log record is then copied into the log buffer 38 by the logger module 31 (step 324). After copying the log record into the log buffer 38, the logger module 31 determines whether the log record requires a timestamp (decision block 326). The logger module 31 may use information associated with the user request, information from the DBMS 29, or information concerning the type of database change performed to determine whether a timestamp is required. If a timestamp is required, the logger module 31 updates the corresponding tracking array element 41 to HAS_TIME (step 330). If no timestamp is required, the logger module 31 updates the corresponding tracking array element 41 to COPIED (step 328).

An exemplary pseudo-code implementation (in part) of a method for writing log records requiring a timestamp is shown below:

```
Function writeLogRecord(myLogRecSize, logRecordHasTime)
{
  take appendLatch;
  returnLso = nextRecLso;
  nextRecLso += myLogRecSize;
  returnLrc = nextRecLrc;
  nextRecLrc += 1;
  release appendLatch;
  myTrackingEntry = getTrackingEntry(returnLrc);
  myTrackingEntry.appendEntryState = USED;
  myTrackingEntry.lrecSize = myLogRecSize;
  myTrackingEntry.lrecLso = returnLso;
  copyLogRecord(returnLrc, returnLso, myLogRecSize);
  if (logRecordHasTime)
    myTrackingEntry.appendEntryState = HAS_TIME;
  else
    myTrackingEntry.appendEntryState = COPIED;
}
```

After writing the log record to the log buffer 38 and updating the corresponding tracking array element 41, a procedure for generating the timestamps is called. In one embodiment, this procedure is a modified version of the getCopyComplete( ) procedure for evaluating the parameters copyComplete and oldestUnfinished.

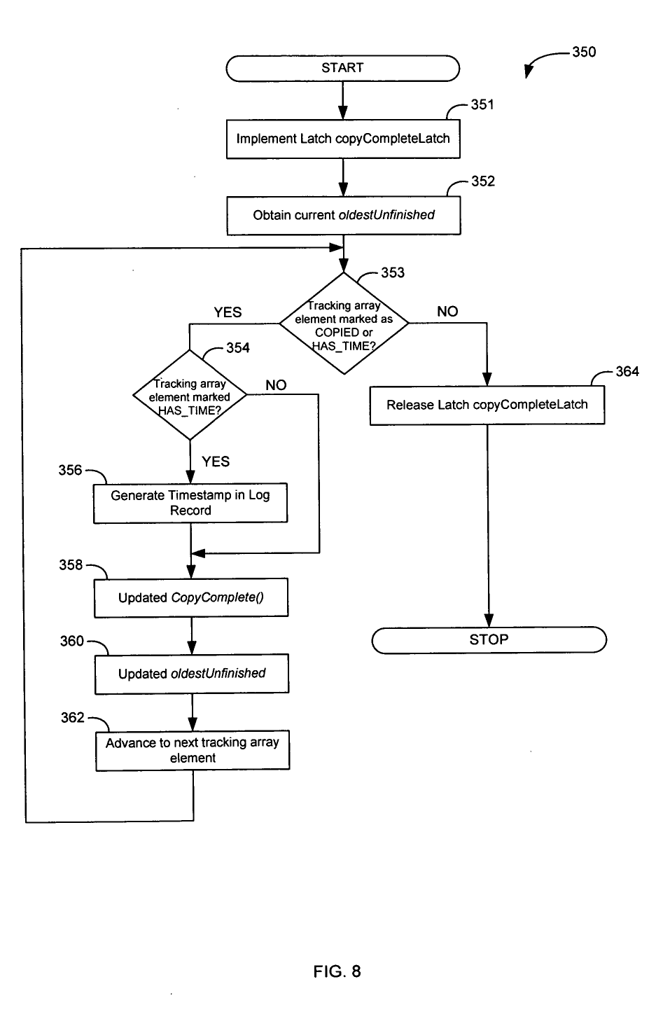

Referring now to FIG. 8, one embodiment of a procedure 350 which updates log information regarding the status of the log buffer 38 and generates timestamps is described. In the first step 351, a latch such as copyCompleteLatch is implemented to prevent a status update from being executed by more than one user request. Next, the current value of the oldestUnfinished parameter is determined (step 352). Starting with the tracking array element 41 indicated by the oldestUnfinished parameter, the logger module 31 determines if the tracking array element 41 is marked as COPIED or HAS_TIME, e.g. in the appendEntryState field (decision block 353). If the tracking array element 41 is so marked, the logger module 31 determines if the tracking array element 41 is marked as HAS_TIME (decision block 354).

If the tracking array element 41 is marked as HAS_TIME, a timestamp is generated in the log record (step 356). If the tracking array element 41 is not marked as HAS_TIME (i.e. it is marked as COPIED), the logger module 31 proceeds to the next step 358.

In the next step 358, the copyComplete parameter is updated to the LSO value (e.g. in lrecLso field) associated with the tracking array element 41. Next, the oldestUnfinished parameter is incremented (step 360). The logger module 31 then advances to the next tracking array element 41 and repeats steps 353 and on (step 362).

If the tracking array element 41 is not marked as COPIED or HAS_TIME (decision block 353), the logger module 31 stops scanning the tracking array 40 and the latch is released (step 364).

An exemplary pseudo-code implementation (in part) of the getCopyComplete( ) procedure which generates timestamps for log records written to the log buffer 38 is shown below:

```
Function getCopyComplete( )
{
  take copyCompleteLatch;
  entry = trackingArray[oldestUnfinished % trackingArraySize];
  while (entry.appendEntryState == COPIED ||
entry.appendEntryState == HAS_TIME)
  {
    if (entry.appendEntryState == HAS_TIME)
    {
      generate timestamp for log record;
    }
    copyComplete = entry.lrecLso + entry.lrecSize;
    returnTrackingEntry(entry);
    oldestUnfinished += 1;
    pLrecEntry = &trackingArray[oldestUnfinished %
    trackingArraySize];
  }
  release copyCompleteLatch
}
```

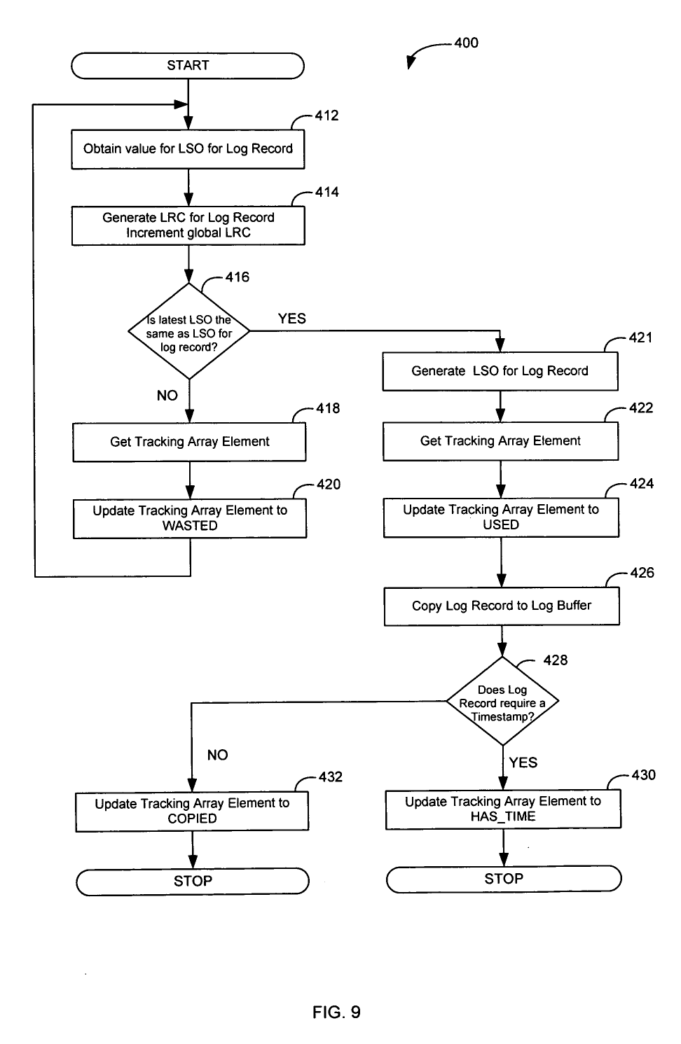

Referring now to FIG. 9, a second embodiment of a procedure 400 for recording a log record in the log buffer 38 is described. The procedure 400 is similar to the procedures 200 and 300, however instead of using a latch for generating the LSO and LRC values for each log record, a pair of atomic counters are used to evaluate the parameters nextRecLrc and nextRecLso. Without using a latch, there exists a risk that user1 may obtain an LRC value but user2 obtains an LRC and LSO value before user1 obtains its LSO. To ensure the LRC and LSO are properly ordered, the LRC value is wasted whenever the LRC and LSO values are obtained out of order. In this embodiment, the appendEntryState field of each tracking array element 41 may also have the value WASTED.

In the first step 412, the logger module 31 obtains an LSO value for the log record. The logger module 31 then generates an LRC value for the log record, and increments a global LRC value by 1 (step 414). Incrementing a global LRC value ensures another log record executing the same step after this point would obtain a different and higher LRC value. In this embodiment, the global LRC value is incremented by the lrcCounter.increment( ) as shown in the pseudo-code below. The increment( ) method for the atomic counter returns the current value of the counter and increments its value by 1. The read_latest( ), increment( ), compareAndSwap( ) methods are all primitive functions associated with atomic counters (i.e. they do not form part of the invention, the invention only makes use of them). A person skilled in the art would understand how to implement this atomic read LRC value and increment it by one (step 414).

The latest LSO is then obtained and compared with the LSO value obtained in the first step 412 (decision block 416). If the LSO values do not match, the LRC and LSO are out of order. A tracking array element 41 is then assigned to the log record (step 418) and the tracking array element 41 is marked as WASTED (step 420). The logger module 31 then repeats steps 412 and on in a subsequent attempt to obtain ordered LRC and LSO values. Such instances typically occur infrequently and so do not create significant costs to the system. The compare and swap may be performed based on LRC values, however this approach result would result in wasting LSO values when the compare and swap fails (due to concurrent log records updating LSO/LRC is out of order). The result would be undesirable but workable, analogous to having holes in the log stream.

If the LSO values do match (decision block 416), the LRC and LSO were obtained in order. An LSO value is then generated of the log record based on the value obtained in step 412 (step 421). A tracking array element 41 is then assigned to the log record (step 422) and the tracking array element 41 is marked as USED (step 424). The log record is then copied into the log buffer 38 by the logger module 31 (step 426). After copying the log record into the log buffer 38, the logger module 31 determines whether the log record requires a timestamp (decision block 428). If a timestamp is required, the logger module 31 updates the corresponding tracking array element 41 to HAS_TIME (step 430). If no timestamp is required, the logger module 31 updates the corresponding tracking array element 41 to COPIED (step 432).

An exemplary pseudo-code implementation (in part) of a method for recording a log records using atomic counters is shown below:

```
Function writeLogRecord(myLogRecSize, logRecordHasTime)
{
  loop
  {
    returnLso = nextRecLso.read_latest( );
    returnLrc = lrecCounter.increment( );
    if (nextRecLso.compareAndSwap(returnLso, returnLso +
    myLogRecSize))
      end loop;
    myTrackingEntry = getTrackingEntry(returnLrc);
    myTrackingEntry.appendEntryState = WASTED;
  }
  myTrackingEntry = getTrackingEntry(returnLrc);
  myTrackingEntry.appendEntryState = USED;
  myTrackingEntry.lrecSize = myLogRecSize;
  myTrackingEntry.lrecLso = returnLso;
  copyLogRecord(returnLrc, returnLso, myLogRecSize);
  if (logRecordHasTime)
    myTrackingEntry.appendEntryState = HAS_TIME;
  else
    myTrackingEntry.appendEntryState = COPIED;
}
```

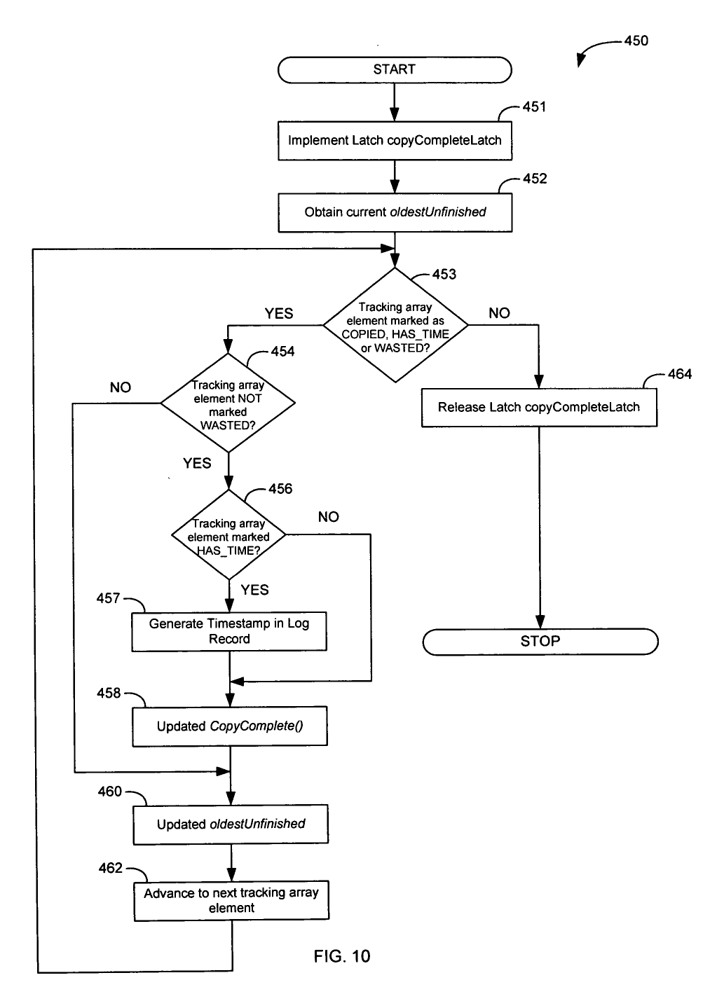

Referring now to FIG. 10, another embodiment of a procedure 450 which updates log information regarding the status of the log buffer 38 and generates timestamps will be described. In the first step 451, a latch such as copyCompleteLatch is implemented to prevent a status update from being executed by more than one user request. Next, the current value of the oldestUnfinished parameter is determined (step 452). Starting with the tracking array element 41 indicated by the oldestUnfinished parameter, the logger module 31 determines if the tracking array element 41 is marked as COPIED, HAS_TIME or WASTED, e.g. in the appendEntryState field (decision block 453). If the tracking array element 41 is not marked as COPIED, HAS_TIME or WASTED, the logger module 31 stops scanning the tracking array 40 and the latch is released (step 464).

If the tracking array element 41 is marked as COPIED, HAS_TIME or WASTED, the logger module 31 then determines if the tracking array element 41 is marked as WASTED (decision block 454). If the tracking array element 41 is marked as WASTED, the logger module 31 then proceeds to step 460. If the tracking array element 41 is not marked as WASTED (i.e. it is marked as COPIED or HAS_TIME), the logger module 31 then determines if the tracking array element 41 is marked as HAS_TIME (decision block 456). If the tracking array element 41 is marked as HAS_TIME, a timestamp is generated in the log record (step 457). If the tracking array element 41 is not marked as HAS_TIME (i.e. it is marked as COPIED), the logger module 31 proceeds to the next step 458.

In the next step 458, the copyComplete parameter is updated to the LSO value (e.g. in lrecLso field) associated with the tracking array element 41. Next, the oldestUnfinished parameter is incremented (step 460). The logger module 31 then advances to the next tracking array element 41 and repeats steps 453 and on (step 462).

An exemplary pseudo-code implementation (in part) of the getCopyComplete( ) procedure for implementing the above procedure is shown below:

```
Function getCopyComplete( )
{
  take copyCompleteLatch;
  entry = trackingArray[oldestUnfinished % trackingArraySize];
  while (entry.appendEntryState == COPIED ||
    entry.appendEntryState == HAS_TIME ||
    entry.appendEntryState == WASTED)
  {
    if (entry.appendEntryState != WASTED)
    {
      if (entry.appendEntryState == HAS_TIME)
      {
        generate timestamp for log record;
      }
      copyComplete = entry.lrecLso + entry.lrecSize;
    }
    returnTrackingEntry(entry);
    oldestUnfinished += 1;
    pLrecEntry = &trackingArray[oldestUnfinished %
    trackingArraySize];
  }
  release copyCompleteLatch
}
```

The present invention is not limited to recording log records made in response to a change to the database, and may be used in other cases which require the logger module 31 is required to write or read a log record. The present invention may also be applied to non-RDBMS implementations, or even to non-database systems, as long as the system needs to have a logger module that records events in an ordered or sequential manner and reads the previously recorded events. Furthermore, the invention is not limited to circular log buffers. Anyone skilled in the field can implement the person invention using a different buffering method. The invention does not depend on how LSO is mapped to a location in the buffer. In an implementation using different buffering methods, all that is needed is a way to map the LSO value to z location in the buffer so the logger module knows where to copy log data into the log buffer, and where to copy data from the log buffer to disk. A circular buffer is used above to illustrate the invention.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. For a database management system, the database management system being capable of concurrently processing and logging multiple database changes, a method for recording a change to a database in a log, the log including a plurality of log records, the method comprising the steps of:
generating a first identifier for mapping to an address in a log buffer for storing a log record describing the change;
generating a second identifier for allocating a tracking descriptor for storing information concerning the log record;
allocating a tracking descriptor for the log record from available tracking descriptors using said second identifier; and
storing the log record at the address in the log buffer.

2. The method as claimed in claim 1, further comprising the steps of:
updating the information stored in the tracking descriptor after the occurrence of each of a plurality of predetermined events; and
copying one or more log records from the log buffer to permanent storage after the information stored in the tracking descriptor has been updated to indicate the one or more log records have been stored in the log buffer.

3. The method as claimed in claim 2, wherein the plurality of predetermined events comprises the group of: allocating the tracking descriptor for the log record, storing the log record at the address in the log buffer, copying the log record from the log buffer to permanent storage, and determining that the log record requires a timestamp.

4. The method as claimed in claim 3, wherein the step of copying one or more log records from the log buffer to permanent storage comprises the steps of:
reading the status information stored in the tracking descriptors to identify one or more log records which have been copied to the log buffer; and
copying the one or more log records from the log buffer to permanent storage; and
releasing the tracking descriptor for the log record so that the tracking descriptor is available for allocation to a new log record.

5. The method as claimed in claim 3, further comprising, after the step of updating the information stored in the tracking descriptor, prior to the step of copying one or more log records from the log buffer to permanent storage, the steps of:
reading the status information stored in the tracking descriptor to determine if the log record requires a timestamp; and
if the log record requires a timestamp,
generating a timestamp for the log record, and
storing the timestamp in the log record.

6. The method as claimed in claim 2, wherein the information stored in the tracking descriptor includes: said first identifier, a size of the log record, and status information concerning the occurrence of a predetermined event affecting the log record.

7. The method as claimed in claim 2, after the step of copying one or more log records from the log buffer to permanent storage, the step of:
increasing a read limit address by an amount proportional to the amount of log data comprised by the one or more log records copied from the log buffer to permanent storage, log records below said read limit address being protected from overwriting during reading.

8. The method as claimed in claim 1, wherein said first identifier has a value derived from a counter which is incremented by the size of the log record, and said second identifier has a value derived from a counter which is incremented for each said second identifier generated.

9. The method as claimed in claim 1, wherein said first identifier is associated with the address in the log buffer for storing the log record.

10. The method as claimed in claim 1, wherein the steps of generating a first identifier and generating a second identifier, comprise the steps of:
implementing a logic latch;
while the logic latch is implemented,
generating said first identifier;
generating said second identifier; and
releasing the logic latch.

11. The method as claimed in claim 1, wherein the steps of generating a first identifier and generating a second identifier, comprise the steps of:
obtaining a value for said first identifier to be generated; and
generating said second identifier;
when the value for said first identifier has not been affected by a second log record describing another database change, generating said first identifier;
when the value for said first identifier has been affected by a second log record describing another database change,
allocating a second tracking descriptor for the log record from available tracking descriptors using said second identifier, and
updating the information stored in the second tracking descriptor to indicate the second tracking descriptor has been allocated; and
repeating the steps of obtaining a value for said first identifier, generating said second identifier, and the conditional steps defined above until the value for said first identifier has not been affected by a log record.

12. The method as claimed in claim 1, wherein the step of storing the log record at the address in the log buffer comprises the steps of:
determining when any log record previously stored at the address in the log buffer to be copied to permanent storage; and
when any log record previously stored at the address in the log buffer has been copied to permanent storage, storing the log record at the address in the log buffer.

13. The method as claimed in claim 1, further comprising the steps of:
receiving a user request to read a log record;
preventing changes to a read limit address in the log buffer, log records below said read limit address being protected from overwriting during reading;
while the read limit address is prevented from changing,
when the address of the log record to be read is below said read limit address,
reading the log record from the log buffer, and
when the address of the log record to be read is above said read limit address,
reading the log record from permanent storage; and
releasing said read limit address to allow it to change.

14. A computer program product having a computer readable medium tangibly embodying code for directing a database management system to record a change to a database in a log, the log including a plurality of log records, the database management system being capable of concurrently processing and logging multiple database changes, the computer program product comprising:
code for generating a first identifier for mapping to an address in a log buffer for storing a log record describing the change;
code for generating a second identifier for allocating a tracking descriptor for storing information concerning the log record;
code for allocating a tracking descriptor for the log record from available tracking descriptors using said second identifier; and
code for storing the log record at the address in the log buffer.

15. The computer program product as claimed in claim 14, further comprising:
code for updating the information stored in the tracking descriptor after the occurrence of each of a plurality of predetermined events; and
code for copying one or more log records from the log buffer to permanent storage after the information stored in the tracking descriptor has been updated to indicate the one or more log records have been stored in the log buffer.

16. The computer program product as claimed in claim 15, wherein the plurality of predetermined events comprises the group of: allocating the tracking descriptor for the log record, storing the log record at the address in the log buffer, copying the log record from the log buffer to permanent storage, and determining that the log record requires a timestamp.

17. The computer program product as claimed in claim 14, wherein the code for generating a first identifier for mapping to an address in a log buffer for storing a log record describing the change and the code for generating a second identifier for allocating a tracking descriptor for storing information concerning the log record is executed in sequence so that said first identifier and said second identifier are generated in order for each log record.

18. The computer program product as claimed in claim 14, further comprising:
code for reading the status information stored in the tracking descriptor to determine if the log record requires a timestamp; and
code responsive to log records requiring a timestamp for,
generating a timestamp for the log record, and
storing the timestamp in the log record.

19. A database management system for recording a change to a database in a log, the log including a plurality of log records, the database management system being capable of concurrently processing and logging multiple database changes, the database management system comprising:
a log buffer;
a logger module responsive to a change to the database, the logger module including,
a module for generating a first identifier for mapping to an address in a log buffer for storing a log record describing the change;
a module for generating a second identifier for allocating a tracking descriptor for storing information concerning the log record;
a module for allocating a tracking descriptor for the log record from available tracking descriptors using said second identifier; and
a module for storing the log record at the address in the log buffer.

20. The database management system as claimed in claim 19, further comprising:
a module for updating the information stored in the tracking descriptor after the occurrence of each of a plurality of predetermined events; and
a module for copying one or more log records from the log buffer to permanent storage after the information stored in the tracking descriptor has been updated to indicate the one or more log records have been stored in the log buffer.
